(19) United States
(12) Patent Application Publication
(10) Pub. No.: US 2026/0221830 A1
(43) Pub. Date: Jul. 30, 2026

(54) ROTATING ELECTRICAL MACHINE

(71) Applicant: AISIN CORPORATION, Kariya (JP)

(72) Inventors: Shunsuke KOYABU, Kariya-shi (JP); Masahiko KATSUDA, Kariya-shi (JP); Hiroaki YABUI, Kariya-shi (JP); Ryohei SUMI, Kariya-shi (JP)

(73) Assignee: AISIN CORPORATION, Kariya (JP)

(21) Appl. No.: 19/383,052

(22) Filed: Nov. 7, 2025

(30) Foreign Application Priority Data
Jan. 30, 2025 (JP) 2025-014216
Sep. 1, 2025 (JP) 2025-144854

(51) Int. Cl. H02K 3/32; H02K 1/16; H02K 3/12

(52) U.S. Cl. CPC H02K 3/32; H02K 1/16; H02K 3/12

(57) ABSTRACT

A rotating electrical machine includes a stator core having a slot, a stator coil formed by a plurality of coil pieces and wound around the stator core, the coil pieces including a general portion in which an insulating film covers a conductor and a portion where the insulating film is removed and exposes the conductor, the stator coil formed by joining the conductor exposed portions at end portions of coil pieces, and an insulating material portion to cover the conductor exposed portion. Paired conductor exposed portions join to each other among the conductor exposed portions of coil pieces include paired non-joint portions continuous with joint portions and face each other, the insulating material portion includes first and second insulating material portions formed on surfaces of facing paired surfaces of the paired non-joint portions, and a gap forms between the first and second insulating material portions.

### CROSS REFERENCE TO RELATED APPLICATIONS

This application is based on and claims priority under 35 U.S.C. § 119 to Japanese Patent Application Nos. 2025-014216 and 2025-144854, filed on Jan. 30, 2025, and Sep. 1, 2025, respectively, the entire contents of which are incorporated herein by reference.

### TECHNICAL FIELD

The present disclosure relates to a rotating electrical machine.

### BACKGROUND DISCUSSION

There is known a method of manufacturing a rotating electrical machine stator in which a rotating electrical machine workpiece in which a plurality of coil pieces forming a stator coil are attached to a stator core is prepared, the distal end portions of the plurality of coil pieces are joined to each other on one end side in an axial direction of the workpiece, a liquid resin material is applied to a target portion including the joint portion (a conductor exposed portion), and then the liquid resin material is cured, so that the joint portion is covered with an insulating material portion (a cured product of the liquid resin material) (for example, Japanese Patent Application Laid-Open No. 2016-124878).

However, in the conventional technique described above, the insulating material portion is provided on the conductor exposed portion including the joint portion with a thickness more than necessary, so that there are problems that the cooling performance of the coil piece is easily lowered and the amount of the resin material used is easily increased.

A need thus exists for a rotating electrical machine which is not susceptible to the drawback mentioned above.

### SUMMARY

A rotating electrical machine includes: a stator core having a slot; a stator coil formed by a plurality of coil pieces and wound around the stator core, the plurality of coil pieces including a general portion in which a conductor is covered with an insulating film and a conductor exposed portion in which the insulating film is removed and the conductor is exposed, the stator coil being formed by joining the conductor exposed portions at end portions of the plurality of coil pieces; and an insulating material portion provided so as to cover the conductor exposed portion. Paired conductor exposed portions to be joined to each other among the conductor exposed portions of the plurality of coil pieces include paired non-joint portions that are continuous with joint portions and face each other. The insulating material portion includes a first insulating material portion formed on one surface of facing paired surfaces of the paired non-joint portions and a second insulating material portion formed on the other surface. A gap is formed between the first insulating material portion and the second insulating material portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view schematically illustrating a cross-sectional structure of a motor according to an embodiment;

FIG. 2 is a plan view of a stator core in a single item state;

FIG. 3 is a diagram schematically illustrating a pair of coil pieces assembled to the stator core;

FIG. 4 is a schematic front view of one coil piece;

FIG. 5 is a schematic diagram illustrating a configuration of a joint portion between the coil pieces of the present embodiment and a periphery thereof, and is a diagram illustrating three pairs of coil pieces as viewed in a radial direction;

FIG. 6 is a diagram illustrating a state where an insulating material portion is removed from FIG. 5;

FIG. 7 is a cross-sectional view taken along line I-I in FIG. 5;

FIG. 8 is a cross-sectional view taken along line II-II in FIG. 5;

FIG. 9 is a diagram illustrating the view illustrated in FIG. 7 for a configuration according to a comparative example;

FIG. 10 is a cross-sectional view taken along line III-III in FIG. 5;

FIG. 11 is a cross-sectional view taken along line III-III in FIG. 5 in a configuration according to another modification;

FIG. 12 is a cross-sectional view taken along line III-III in FIG. 5 in the configuration according to the comparative example; and

FIG. 13 is an explanatory diagram of a coil piece according to a modification.

### DETAILED DESCRIPTION

Hereinafter, each embodiment will be described in detail with reference to the drawings. Note that the dimensional ratios in the drawings are merely examples, and the dimensional ratios are not limited thereto, and shapes and the like in the drawings may be partially exaggerated for convenience of description. In addition, in the drawings, only some of a plurality of portions having the same attribute may be denoted by reference numerals for the sake of clarity.

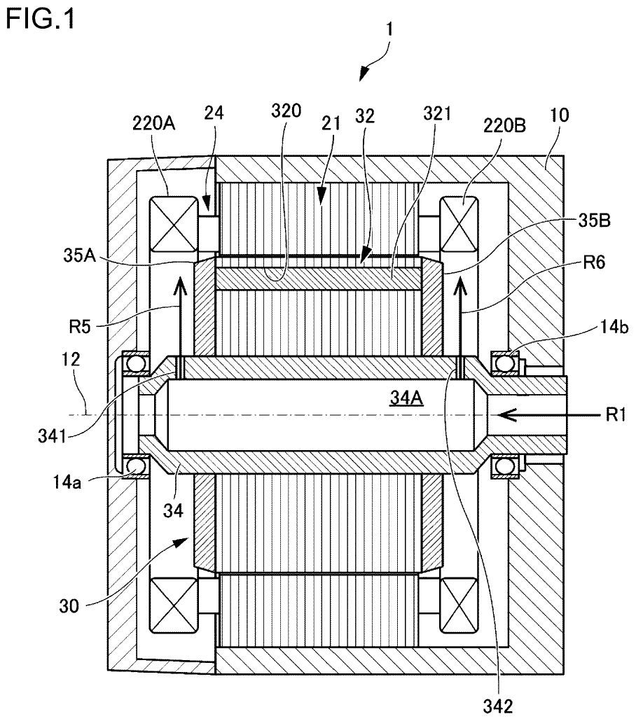

FIG. 1 is a cross-sectional view schematically illustrating a cross-sectional structure of a motor 1 (an example of a rotating electrical machine) according to an embodiment.

FIG. 1 illustrates a rotation axis 12 of the motor 1. In the following description, the axial direction refers to a direction in which the rotation axis (the rotation center) 12 of the motor 1 extends, and the radial direction refers to a radial direction around the rotation axis 12. Therefore, the radially outer side refers to a side away from the rotation axis 12, and the radially inner side refers to a side toward the rotation axis 12. In addition, the circumferential direction corresponds to a rotation direction around the rotation axis 12.

The motor 1 may be, for example, a vehicle drive motor used in a hybrid vehicle or an electric vehicle. Here, the motor 1 may be used for any other application.

The motor 1 is an inner rotor type, and is provided in a manner that a stator 21 surrounds the radially outer side of a rotor 30. The radially outer side of the stator 21 is fixed to a motor housing 10.

The rotor 30 is disposed on the radially inner side of the stator 21. The rotor 30 includes a rotor core 32 and a rotor shaft 34. The rotor core 32 is fixed to the radially outer side of the rotor shaft 34 and rotates integrally with the rotor shaft 34. The rotor shaft 34 is rotatably supported by the motor housing 10 via bearings 14a and 14b. Note that the rotor shaft 34 defines the rotation axis 12 of the motor 1.

The rotor core 32 is made of, for example, annular magnetic laminated steel plates. A permanent magnet 321 is inserted into a magnet hole 320 of the rotor core 32. The number, arrangement, and the like of the permanent magnets 321 are arbitrary. In a modification, the rotor core 32 may be formed of a green compact obtained by compressing and solidifying magnetic powder.

End plates 35A and 35B are attached to both sides in the axial direction of the rotor core 32. The end plates 35A and 35B may have a function of adjusting the imbalance of the rotor 30 (a function of eliminating the imbalance by cutting or the like) in addition to a support function of supporting the rotor core 32.

As illustrated in FIG. 1, the rotor shaft 34 has a hollow portion 34A. The hollow portion 34A extends over the entire length in the axial direction of the rotor shaft 34. The hollow portion 34A may function as an oil passage. For example, as indicated by an arrow R1 in FIG. 1, oil is supplied to the hollow portion 34A from one end side in the axial direction, and the oil flows along the radially inner surface of the rotor shaft 34, so that the rotor core 32 can be cooled from the radially inner side. Furthermore, the oil flowing along the radially inner surface of the rotor shaft 34 may be ejected radially outward through oil holes 341 and 342 formed at both end portions of the rotor shaft 34 (arrows R5 and R6) to be used for cooling coil ends 220A and 220B.

Note that, although FIG. 1 illustrates the motor 1 with a specific structure, the structure of the motor 1 is arbitrary as long as the motor 1 includes a stator coil 24 (described later) joined by welding. Therefore, for example, the rotor shaft 34 need not have the hollow portion 34A, or may have a hollow portion with a significantly smaller inner diameter than the hollow portion 34A. Furthermore, although a specific cooling method is disclosed in FIG. 1, the method of cooling the motor 1 is arbitrary. Therefore, for example, an oil introduction pipe inserted into the hollow portion 34A may be provided, or oil may be dropped from the oil passage in the motor housing 10 toward the coil ends 220A and 220B from the radially outer side.

Moreover, the inner rotor type motor 1 in which the rotor 30 is disposed inside the stator 21 is illustrated in FIG. 1, but the present disclosure may be applied to a motor of another form. For example, the present disclosure may be applied to an outer rotor type motor in which the rotor 30 is concentrically disposed outside the stator 21, a dual rotor type motor in which the rotor 30 is disposed both outside and inside the stator 21, and the like.

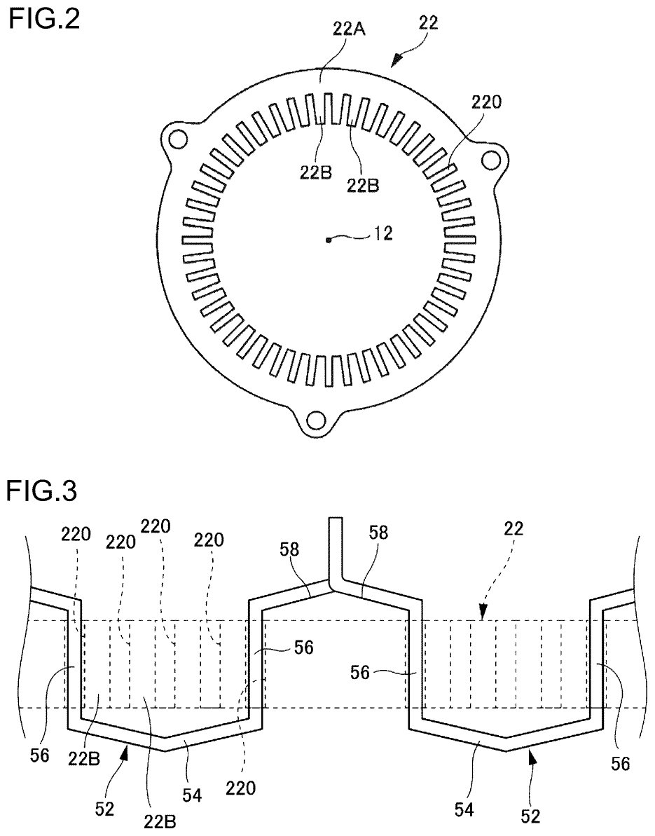

Next, a configuration related to the stator 21 will be described in detail with reference to FIG. 2 and subsequent drawings.

FIG. 2 is a plan view of a stator core 22 in a single item state. FIG. 3 is a diagram schematically illustrating a pair of coil pieces 52 assembled to the stator core 22. FIG. 3 illustrates the relationship between the pair of coil pieces 52 and a slot 220 in a state where the radially inner side of the stator core 22 is developed. Furthermore, in FIG. 3, the stator core 22 is indicated by a dotted line, and some of the slots 220 are not illustrated.

The stator 21 includes the stator core 22 and the stator coil 24.

The stator core 22 is made of, for example, annular magnetic laminated steel plates, but in a modification, the stator core 22 may be formed of a green compact obtained by compressing and solidifying magnetic powder. Note that the stator core 22 may be formed by split cores split in the circumferential direction, or may be in a form not split in the circumferential direction. A plurality of slots 220 around which the stator coil 24 is wound are formed on the radially inner side of the stator core 22. Specifically, as illustrated in FIG. 2, the stator core 22 includes an annular back yoke 22A and a plurality of teeth 22B extending radially inward from the back yoke 22A, and the slots 220 are formed between the plurality of teeth 22B in the circumferential direction. The number of slots 220 is arbitrary, but is 48 in the present embodiment as an example.

The stator coil 24 includes a U-phase coil, a V-phase coil, and a W-phase coil (hereinafter, the U-phase coil, the V-phase coil, and the W-phase coil will be referred to as “phase coils” when U, V, and W are not distinguished). The proximal end of each phase coil is connected to an input terminal (not illustrated), and the terminal end of each phase coil is connected to the terminal end of another phase coil to form a neutral point of the motor 1. That is, the stator coil 24 is star-connected. Here, the connection mode of the stator coil 24 may be changed as appropriate depending on required motor characteristics and the like, and for example, the stator coil 24 may be delta-connected instead of being star-connected.

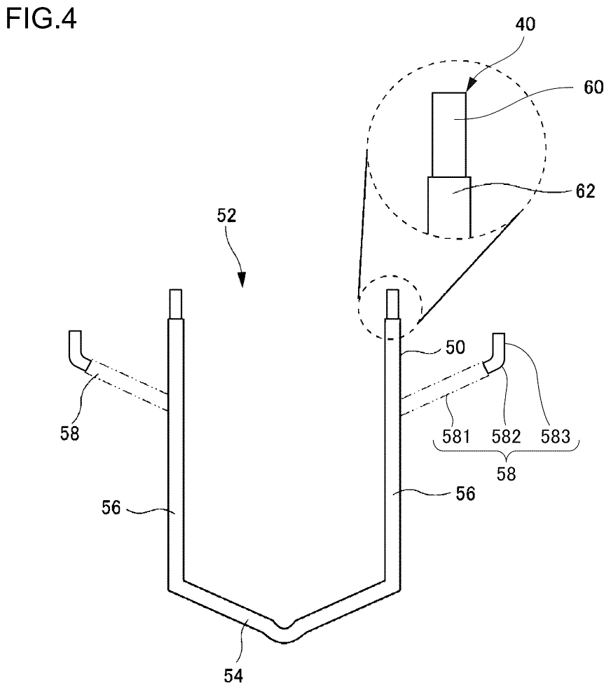

Each phase coil is formed by joining a plurality of coil pieces 52. FIG. 4 is a schematic front view of one coil piece 52. The coil piece 52 is in the form of a segment coil obtained by dividing the phase coil into units that are easy to assemble (for example, units to be inserted into the two slots 220). The coil piece 52 is formed by coating a linear conductor (a rectangular wire) 60 with a rectangular cross-section with an insulating film 62. In the present embodiment, the linear conductor 60 is made of copper, for example. Here, in the modification, the linear conductor 60 may be made of another conductor material such as iron.

Before being assembled to the stator core 22, the coil piece 52 may be formed in a substantially U-shape having a pair of straight portions 50 and a coupling portion 54 that couples the pair of straight portions 50. When the coil piece 52 is assembled to the stator core 22, each of the pair of straight portions 50 is inserted into the slot 220 (see FIG. 3). As a result, as illustrated in FIG. 3, the coupling portion 54 extends over the plurality of teeth 22B (and the plurality of slots 220 accordingly) in the circumferential direction on the other end side in the axial direction of the stator core 22. The number of slots 220 over which the coupling portion 54 extends is arbitrary, but is three in FIG. 3. Furthermore, after being inserted into the slot 220, the straight portion 50 is bent midway in the circumferential direction as indicated by a two-dot chain line in FIG. 4. As a result, the straight portion 50 becomes a slot insertion portion 56 extending in the axial direction in the slot 220 and a connecting portion 58 extending in the circumferential direction on one end side in the axial direction of the stator core 22. Note that the connecting portion 58 forms the coil end 220A.

Note that, in FIG. 4, the paired straight portions 50 are bent in directions away from each other, but it is not limited thereto. For example, the paired straight portions 50 may be bent in directions approaching each other. In addition, the stator coil 24 may also have a neutral point coil piece or the like for coupling terminal ends of three-phase coils to form a neutral point.

A plurality of slot insertion portions 56 of the coil pieces 52 illustrated in FIG. 4 are inserted into one slot 220 side by side in the radial direction. Therefore, a plurality of connecting portions 58 extending in the circumferential direction are arranged in the radial direction on one end side in the axial direction of the stator core 22. As illustrated in FIG. 3, the connecting portion 58 of one coil piece 52 that protrudes from one slot 220 and extends toward the circumferential first side (for example, the clockwise direction) is joined to the connecting portion 58 of the other coil piece 52 that protrudes from the other slot 220 and extends toward the circumferential second side (for example, the counterclockwise direction).

In the present embodiment, as an example, the connecting portion 58 has an oblique portion 581 extending axially outward and in the circumferential direction, a bent R portion 582, and an axial end portion 583 extending in the axial direction.

In the present embodiment, as an example, six coil pieces 52 are assembled to one slot 220. Hereinafter, the coil pieces are also referred to as a first turn coil piece, a second turn coil piece, and a third turn coil piece in order from the outermost coil piece 52 in the radial direction. In this case, distal end portions 40 of the first turn coil piece 52 and the second turn coil piece 52 are joined to each other in a joining step, the distal end portions 40 of the third turn coil piece 52 and the fourth turn coil piece 52 are joined to each other in the joining step, and the distal end portions 40 of the fifth turn coil piece 52 and the sixth turn coil piece 52 are joined to each other in the joining step.

The joining step may be performed by any method, for example, welding, or may be performed by a method other than welding (for example, brazing). Furthermore, the joining range is the distal end portion 40 of the axial end portion 583, but details such as the size thereof are arbitrary.

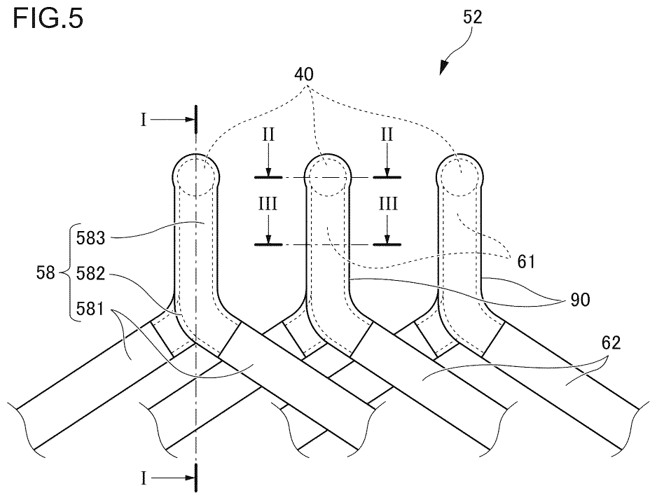

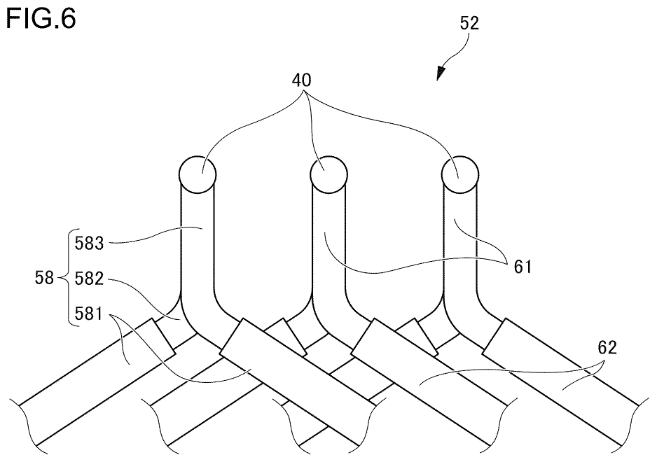

FIG. 5 is a schematic diagram illustrating a configuration of a joint portion between the coil pieces 52 of the present embodiment and a periphery thereof, and is a diagram illustrating three pairs of coil pieces 52 as viewed in the radial direction. FIG. 6 is a diagram illustrating a state where an insulating material portion 90 is removed from FIG. 5;

Here, as described above, the coil piece 52 is covered with the insulating film 62 in a general portion (the slot insertion portion 56 and the like), but the insulating film 62 is removed in the axial end portion 583 and the like including the distal end portion 40 unlike the general portion. This is to ensure electrical connection with the other coil piece 52 at the distal end portion 40 of the axial end portion 583. The cut line of the insulating film 62 is arbitrary, but may be set in a plane in which the extending direction of the linear conductor 60 of the corresponding portion is the normal direction.

In the present embodiment, the portion (hereinafter, also referred to as “conductor exposed portion 61”) in which the insulating film 62 is removed and the linear conductor 60 is exposed includes the axial end portion 583 and the bent R portion 582.

In the present embodiment, as schematically illustrated in FIG. 5, the insulating material portion 90 is provided so as to cover the conductor exposed portion 61. The insulating material portion 90 may be any insulating material such as a resin material, and may contain a filler or the like. The insulating material portion 90 may be formed by, for example, electrodeposition coating. In this case, the insulating material portion 90 can be efficiently formed on the conductor exposed portion 61.

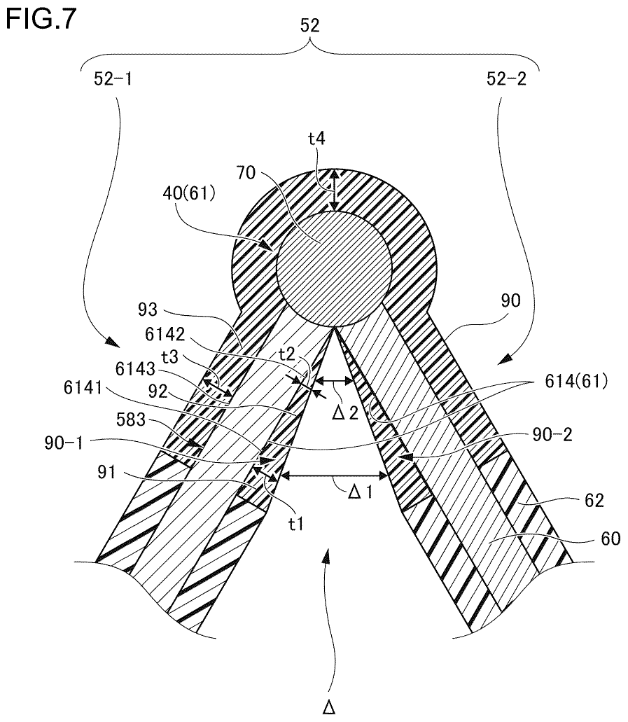

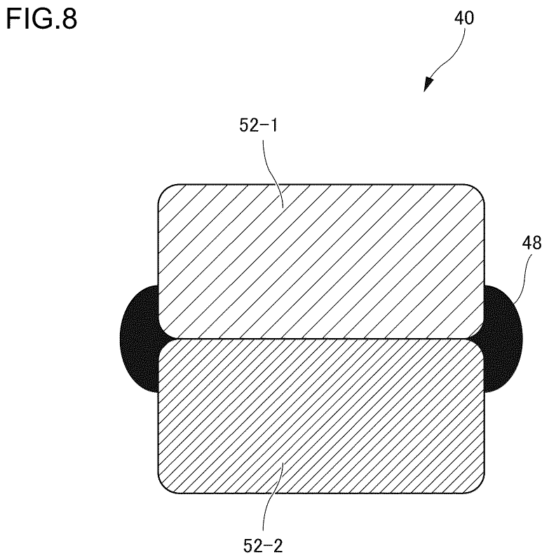

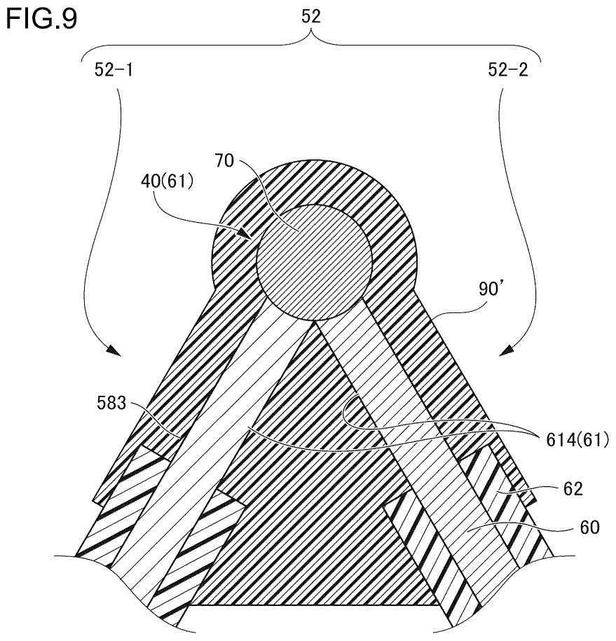

FIG. 7 is a cross-sectional view taken along line I-I in FIG. 5, and FIG. 8 is a cross-sectional view taken along line II-II in FIG. 5. FIG. 9 is a diagram illustrating the view illustrated in FIG. 7 for a configuration according to a comparative example. In FIG. 7, a range 70 of a joint portion is schematically illustrated.

In FIG. 7, paired coil pieces 52 joined to each other are illustrated. In this case, the individual coil pieces 52 forming the pair of coil pieces 52 are also referred to as a coil piece 52-1 and a coil piece 52-2 when distinguished.

As described above, the distal end portions 40 of the axial end portions 583 of the coil piece 52-1 and the coil piece 52-2 are joined to each other. Note that, in FIG. 7, the axial end portions 583 are illustrated with their inclinations exaggerated for the sake of explanation, but in practice, the axial end portions are substantially parallel to the axial direction, and inclinations (inclinations in the illustrated directions) are formed in directions in which the distal end portions 40 approach each other in view of the relationship in which the distal end portions 40 are joined to each other (see FIG. 8). Hereinafter, in the view illustrated in FIG. 7, the sides of the two axial end portions 583 facing each other are also referred to as “facing sides”, and the opposite sides are also referred to as “non-facing sides”.

Note that in the example illustrated in FIG. 8, the distal end portions 40 are joined to each other via a welded portion 48 on the side (circumferential side) of the mating surface, but may be joined to each other via a welded portion (not illustrated) on the axially outer side of the mating surface instead of or in addition to the welded portion 48.

In the present embodiment, the joint portion (see the range 70 in FIG. 7) of the conductor exposed portion 61 to be joined is not the entire conductor exposed portion 61 but the distal end portion 40 of the axial end portion 583. Therefore, the surfaces of non-joint portions 614 of the conductor exposed portions 61 on the facing side are separated from each other as illustrated in FIG. 8. The paired non-joint portions 614 of the paired axial end portions 583 to be joined extend in the axial direction in a manner of radially facing each other. Note that the non-joint portion 614 is a portion of the conductor exposed portion 61 excluding the joint portion, and specifically includes a portion of the axial end portion 583 excluding the distal end portion 40 and the bent R portion 582 (see FIG. 5).

In the present embodiment, the insulating material portion 90 is formed on the paired non-joint portions 614 in a manner that a gap A is formed on the facing side. That is, an insulating material portion 90-1 (an example of a first insulating material portion) formed on the non-joint portion 614 of the coil piece 52-1 and an insulating material portion 90-2 (an example of a second insulating material portion) formed on the non-joint portion 614 of the coil piece 52-2 are not integrated with each other, and the gap A is formed on the facing side.

Here, the comparative example illustrated in FIG. 9 is different from the present embodiment in that the insulating material portion 90 is replaced with an insulating material portion 90′. The insulating material portion 90′ is formed between the facing sides of the paired non-joint portions 614 without any gap, as illustrated in FIG. 9. In such a comparative example, since cooling oil cannot be supplied to the facing sides of the paired non-joint portions 614, there is a problem that the cooling performance of the conductor exposed portion 61 is not good. In addition, there is a problem that the amount of material used to form the insulating material portion 90′ is relatively large, and the material cost increases.

On the other hand, in the present embodiment, as described above, the gap A of the insulating material portion 90 is formed between the facing sides of the paired non-joint portions 614. As a result, oil can reach the gap 4, and the cooling performance of the conductor exposed portion 61 can be enhanced. In addition, the amount of material used to form the insulating material portion 90 can be relatively small, and the material cost can be reduced.

Note that the gap A need not be formed over the entire non-joint portion 614, and may be formed at least on the root side (the axially inner side) of the non-joint portion 614. That is, the gap A need not be formed in a portion of the non-joint portion 614 adjacent to the joint portion.

In the present embodiment, the gap A is formed to be larger on the root side (the axial inner side) of the non-joint portion 614 than on the axial outer side. For example, as illustrated in FIG. 7, the gap A is formed so as to gradually increase from the root side (the axial inner side) of the non-joint portion 614 toward the axial outer side. Specifically, for the thickness of the insulating material portion 90, assuming that the thickness of a material portion 91 (an example of the first and second insulating material portions) on a root-side (an axially inner) surface 6141 (an example of a first surface portion) on the facing side of the non-joint portion 614 is t1 (an example of a first thickness), and the thickness of a material portion 92 (an example of the first and second insulating material portions) on an axially outer surface 6142 (an example of a second surface portion) on the facing side of the non-joint portion 614 is t2 (an example of a second thickness), t1>t2 is satisfied. t1 may be significantly larger than t2.

Here, the cooling oil can contain foreign matter (for example, chips, metal pieces, or the like), and if the foreign matter hits the insulating material portion 90, the insulating material portion 90 may be damaged. The larger the thickness of the insulating material portion 90, the smaller the influence of the damage by the foreign matter can be.

In this regard, according to the present embodiment, as described above, by setting t1>t2, it is possible to obtain a thickness profile based on the degree of possibility (frequency) that the foreign matter hits. That is, a gap 42 between the facing sides of the material portions 92 on the axially outer side is smaller than a gap 41 between the facing sides of the material portions 91. Therefore, the possibility (the frequency) that the foreign matter hits the material portion 92 is lower than that of the material portion 91. Correspondingly, by setting t1>t2, it is possible to achieve both the reduction in the amount of material used and the improvement in resistance to the foreign matter.

Furthermore, in the present embodiment, for the thickness of the insulating material portion 90, assuming that the thickness of a material portion 93 on a non-facing-side surface 6143 of the non-joint portion 614 is t3 (an example of a third thickness), and the thickness around the distal end portion 40 is t4 (an example of a fourth thickness), t4≥t3 is satisfied. At this time, t3 is equal to or larger than t1 described above. That is, t4≥t3≥t1>t2. By making t3 relatively large as described above, even in a case where the coil piece 52 of a different phase is disposed on the non-facing side, required insulation with the coil piece 52 of a different phase can be ensured. In addition, by making t4 relatively large, it is easy to ensure required insulation even when the distance from the motor housing 10 to the distal end portion 40 is shortened. As a result, the axial size of the motor 1 including the motor housing 10 can be reduced.

Here, the foreign matter described above that can be contained in the cooling oil easily hits the non-facing side of the non-joint portion 614 rather than the facing side. Therefore, in the present embodiment, by making t3 and t4 relatively large, the influence of damage by the foreign matter can be reduced.

As described above, in the present embodiment, the insulating material portion 90 is not formed on the conductor exposed portion 61 with the same thickness, but is formed to have different appropriate thicknesses at the individual portions, as illustrated in FIG. 7. As a result, it is possible to ensure required insulation while enhancing the cooling performance of the coil end 220A. In addition, the amount of the insulating material used can be reduced, and the axial size of the motor 1 can be reduced.

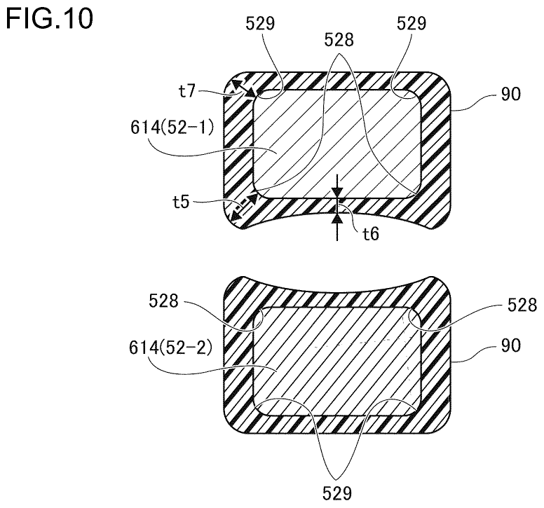

Next, further features of the present embodiment will be described with reference to FIGS. 10 to 12.

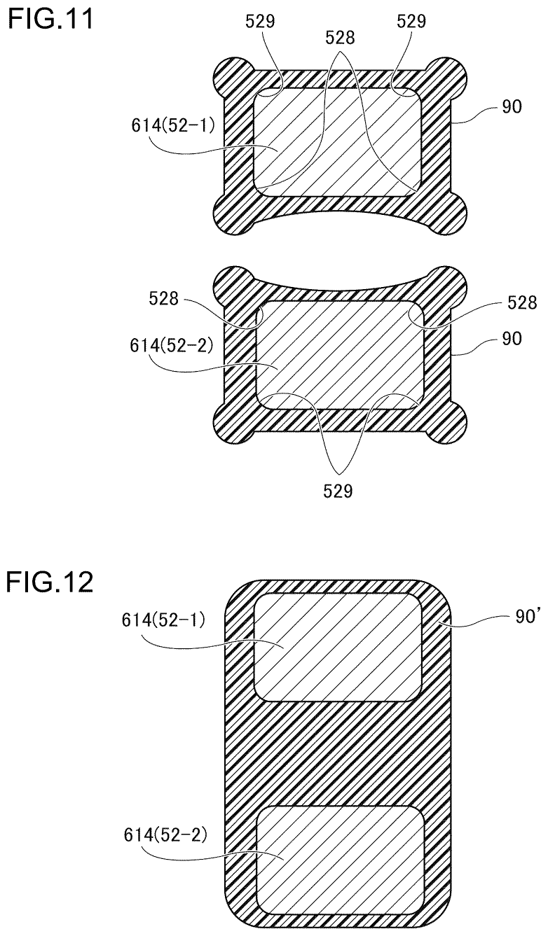

FIG. 10 is a cross-sectional view taken along line III-III in FIG. 5. FIG. 11 is a cross-sectional view taken along line III-III in FIG. 5 in a configuration according to another modification. FIG. 12 is a cross-sectional view taken along line III-III in FIG. 5 in the configuration according to the comparative example.

In the present embodiment, the insulating material portion 90 is formed on the surfaces of the paired non-joint portions 614 with the following thickness profile. That is, for the thickness of the insulating material portion 90 on the facing side of the coil piece 52, assuming that the thickness at corner portions 528 on both sides is t5 and the thickness at an intermediate position between the corner portions 528 on both sides is t6, t5>t6 is satisfied. Here, the thickness at the corner portion 528 may be a thickness along a diagonal line of a rectangular cross-section. Note that the rectangular cross-section may have an corner R, and also in this case, the diagonal line can be defined.

The change mode from t5 to t6 is arbitrary, and may change relatively smoothly as illustrated in FIG. 10. In the example illustrated in FIG. 10, t6 is a minimum value, and the thickness gradually increases nonlinearly (in a form protruding toward the non-facing side) toward the corner portion 528. Here, as in the modification illustrated in FIG. 11, only the corner portion 528 may protrude convexly to the non-facing side. That is, the section of t6 (a substantially constant value) may include a relatively long section between the corner portions 528 on both sides.

In addition, assuming that the thickness at a corner portion 529 on the non-facing side is t7, as illustrated in FIG. 10, t5>t7 may be satisfied. In this case, t6~t7 may be satisfied. Alternatively, as illustrated in FIG. 11, t5=t7 may be satisfied. That is, all four corner portions 528 and 529 may have a relatively large thickness.

Here, since the electric field concentrates at the corner portions 528 and 529 when the stator coil 24 is energized, it is desirable that the thickness of the insulating material portion 90 is relatively large. In this regard, according to the present embodiment, as described above, since the thickness of the insulating material portion 90 at the corner portion 528 is relatively large, required insulation can be ensured. In addition, the electric field concentration does not occur at the intermediate position between the corner portions 528, and the thickness of the insulating material portion 90 can be made relatively small. In this regard, in the present embodiment, since t6 is relatively small as described above, the amount of material used can be made relatively small, and the material cost can be reduced.

Furthermore, in the present embodiment, as described above, although the thickness of the corner portion 528 is relatively large, the gap A is provided on the facing side. Note that the radial length of the gap A is minimized at the corner portion 528 and is relatively large at the intermediate position between the corner portions 528 on both sides. By having such a gap 4, as described above, the cooling performance of the coil end 220A can be enhanced. In addition, since the gap A is also ensured between the facing corner portions 528, the flow of oil is promoted (hardly stagnates), and the cooling performance is improved.

Note that the comparative example illustrated in FIG. 12 is the same as the comparative example illustrated in FIG. 9, and there is no gap 4, and there is a problem that the cooling performance of the conductor exposed portion 61 is not good. In addition, there is a problem that the amount of material used to form the insulating material portion 90′ is relatively large, and the material cost increases.

Although each embodiment has been described in detail above, the present disclosure is not limited to a specific embodiment, and various modifications and changes can be made within the scope described in the claims. In addition, all or a plurality of the components of the embodiments described above can be combined.

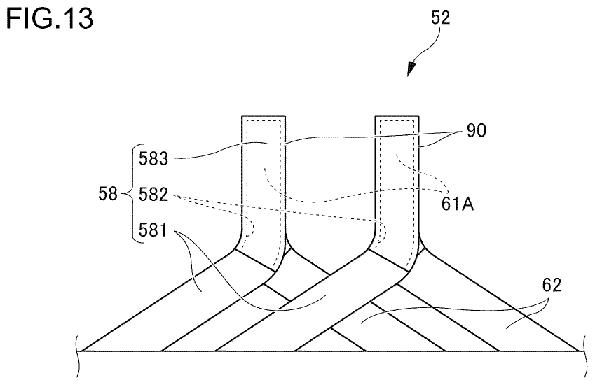

For example, in the embodiment described above, the conductor exposed portion 61 includes the axial end portion 583 and the bent R portion 582, but as in the modification illustrated in FIG. 13, a conductor exposed portion 61A may include the axial end portion 583 and a part of the bent R portion (a portion on the axial end portion 583 side).

A rotating electrical machine includes: a stator core having a slot; a stator coil formed by a plurality of coil pieces and wound around the stator core, the plurality of coil pieces including a general portion in which a conductor is covered with an insulating film and a conductor exposed portion in which the insulating film is removed and the conductor is exposed, the stator coil being formed by joining the conductor exposed portions at end portions of the plurality of coil pieces; and an insulating material portion provided so as to cover the conductor exposed portion. Paired conductor exposed portions to be joined to each other among the conductor exposed portions of the plurality of coil pieces include paired non-joint portions that are continuous with joint portions and face each other. The insulating material portion includes a first insulating material portion formed on one surface of facing paired surfaces of the paired non-joint portions and a second insulating material portion formed on the other surface. A gap is formed between the first insulating material portion and the second insulating material portion.

In one aspect, according to the present disclosure, it is possible to appropriately provide the insulating material portion on the conductor exposed portion including the joint portion.

In the rotating electrical machine, each of the paired non-joint portions includes, on a facing side, a first surface portion in which the conductor exposed portions are separated from each other by a first distance and a second surface portion in which the conductor exposed portions are separated from each other by a second distance larger than the first distance, the first insulating material portion and the second insulating material portion are formed on the first surface portion with a first thickness and formed on the second surface portion with a second thickness, and the second thickness is larger than the first thickness.

In the rotating electrical machine, the insulating material portion is formed with a third thickness on a side opposite to a side in which the paired non-joint portions face each other, and the third thickness is equal to or larger than the first thickness.

In the rotating electrical machine, the insulating material portion is formed with a fourth thickness on a side opposite to a side in which the joint portions face each other or on an axial outer side of the joint portion, and the fourth thickness is equal to or larger than the third thickness.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotating electrical machine comprising:
a stator core having a slot;
a stator coil formed by a plurality of coil pieces and wound around the stator core, the plurality of coil pieces including a general portion in which a conductor is covered with an insulating film and a conductor exposed portion in which the insulating film is removed and the conductor is exposed, the stator coil being formed by joining the conductor exposed portions at end portions of the plurality of coil pieces; and
an insulating material portion provided so as to cover the conductor exposed portion, wherein
paired conductor exposed portions to be joined to each other among the conductor exposed portions of the plurality of coil pieces include paired non-joint portions that are continuous with joint portions and face each other,
the insulating material portion includes a first insulating material portion formed on one surface of facing paired surfaces of the paired non-joint portions and a second insulating material portion formed on the other surface, and
a gap is formed between the first insulating material portion and the second insulating material portion.

2. The rotating electrical machine according to claim 1, wherein each of the paired non-joint portions includes, on a facing side, a first surface portion in which the conductor exposed portions are separated from each other by a first distance and a second surface portion in which the conductor exposed portions are separated from each other by a second distance larger than the first distance,
the first insulating material portion and the second insulating material portion are formed on the first surface portion with a first thickness and formed on the second surface portion with a second thickness, and
the second thickness is larger than the first thickness.

3. The rotating electrical machine according to claim 2, wherein the insulating material portion is formed with a third thickness on a side opposite to a side in which the paired non-joint portions face each other, and
the third thickness is equal to or larger than the first thickness.

4. The rotating electrical machine according to claim 3, wherein the insulating material portion is formed with a fourth thickness on a side opposite to a side in which the joint portions face each other or on an axial outer side of the joint portion, and
the fourth thickness is equal to or larger than the third thickness.
